(19) United States
(12) Patent Application Publication
(10) Pub. No.: US 2003/0185212 A1
(43) Pub. Date: Oct. 2, 2003

(54) Circuit emulation service

(76) Inventors: Michael Kelly, St. Albans (GB); Malcolm Wallace, Bishops Stortford (GB); Marija Spasic, Ottawa (CA); Robert Roust, London (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/109,776

(22) Filed: Mar. 29, 2002

(51) Int. Cl. H04L 12/56

(52) U.S. Cl. 370/395.1

(57) ABSTRACT

TDM (time division multiplexed) traffic is transported together with a TDM performance monitoring channel over a ATM (asynchronous transfer mode) network. The TDM traffic is segmented at ingress to the ATM network and is packed as payload data into ATM cells. Each cell payload is provided with an AAL1 segmentation and reassembly protocol data unit (SAR-PDU) containing a channel state information (CIS) field, a sequence number field, and a sequence number protection field. A performance monitoring channel is provided by utilising spare bits in the CIS field in alternate cells. On egress from the ATM network, the sequence number protection and performance monitoring data provide a means of identifying both missing and corrupted cells so as to determine a measure of the quality of transport of the TDM traffic over the ATM network. The measured transmission quality may be compared with service levels defined in a service level agreement.

### FIELD OF THE INVENTION

This invention relates to communications networks, and in particular to an arrangement and method for providing a circuit emulation service over a communications network.

### BACKGROUND OF THE INVENTION

Telecommunications voice traffic has traditionally been transported over time division multiple and (TDM) networks. These networks, which are connection oriented, typically transport the traffic in the standard SDH (Synchronous Digital Hierarchy) SONET format in which the digitalised frame-based traffic is transported in virtual containers.

Recently, asynchronous (ATM) networks have been introduced for long haul transport or both voice and data traffic. These networks transport traffic in cells, and have the considerable advantage that different types of traffic from several different users can be multiplexed onto a single virtual circuit connection. This enables efficient usage of the network and maximises the operator's revenue.

Communications systems are now being developed in which TDM voice traffic is transported over an ATM network. At an ingress to the ATM network, the frame based voice traffic is packaged into cells, and on egress from the ATM network the cell payloads are reassembled into the TDM frame format for onward transmission within the TDM domain. A particular issue that has had to be addressed in the transport of TDM traffic over an ATM network is that of maintaining the connection oriented nature of the transmission so that, from the perspective of the TDM network operator, all of the TDM properties, including performance monitoring, are maintained end to end.

A preferred technique for providing end to end TDM transport via an ATM network is the circuit emulation service (CES). This protocol, which provides a mechanism for transporting data at a constant bit rate across an ATM network, is used for traffic derived from a TDM connection or circuit, which is carried over ATM using CES, and is then restored to a corresponding TDM circuit at the far-end. Thus, each end-user interworks effectively with a TDM “tail”, and the aim of CES is to preserve the communication characteristics which the user would have experienced had the connection remained within the TDM domain throughout the network. This aim is reflected in the needs of the network operator(s) involved, who use CES as an alternative network technology to conventional TDM (i.e. PDH, SONET/SDH, etc.) but who wish to maintain the service levels offered to their customers, i.e. the end-users. Typically, these service levels are embodied in service level agreements (SLA) which form a contractual commitment between operator(s) and customers(s) concerning the service provided. These contracts specify quality factors such as a maximum allowable error rate. Services such as the provision of private lines, at various data rates, are common applications of CES in this way.

In such an arrangement there is a finite possibility that data errors can be introduced into the data carried as CES payloads over the ATM network, and thus that the users will experience data errors in their communication channel. Service level agreements agreed between the provider of the communication service (the Operator) and the user (the Customers) govern the type and level of error (service impairments), which can be tolerated before particular consequences result (typically, some form of financial penalty). Monitoring the quality of the data carried, and of errors introduced, is a key aspect of operating service level agreements.

A major aspect of operating service level agreements (SLA) is the ability of the network operator to monitor the performance of the services provided and to use this performance monitoring as a basis for assessing service quality and for identifying any SLA violations. The SLA would normally guarantee for example that only a specified number of service impairments will occur during the SLA period (typically, some weeks or months), and performance monitoring is necessary to calculate the number of relevant impairments which apply.

However, while there are established methods of error detection and monitoring within the TDM domain, there is at present no fully effective method of detecting and monitoring errors that are introduced into the TDM traffic during its transport in the ATM domain. This detracts from the principle of transparent end to end transmission and diminishes the ability of the network operator to ensure that the quality requirements of the service level agreement (SLA) are being met.

A set of SLA measures are commonly used for TDM services such as private lines. The most generally-used measures are BER (block, or bit, error ratio), ES (errored seconds), SES (severely-errored seconds) and UA (unavailability). These measures are defined in the relevant TDM standards.

The current approach to the problem of ensuring conformance with the service level agreement is based on CES (see ref: ATMF Circuit Emulation Service Interoperability Specification Version 2.0). However, in this current method, no provision is made for any form of error checking of the payload which contains the user data derived from the TDM circuit concerned. In particular, there are no available fields in the ATM cell header which might be used for this purpose. Thus, it is not possible to measure directly any errors which may affect this payload data during transport over the ATM network. At present, such measurements are derived indirectly using statistical techniques which give meaningful results only over a significant time period, typically several days. As a consequence, no direct performance monitoring of the payload data is currently available within existing standards and agreements, and the required SLA measures (BER, ES, etc.) cannot therefore be derived directly.

### SUMMARY OF THE INVENTION

An object of the invention is to minimise or to overcome the above disadvantage.

A further object of the invention is to provide an improved method of providing TDM performance data for TDM traffic transported over a ATM network.

According to a first aspect of the invention there is provided a method of providing performance monitoring data for time division multiplexed (TDM) traffic transported in cells, each having a header and a payload, over an asynchronous (ATM) network, the method comprising; providing a TDM performance monitoring channel embodied as a sequence of bits, said bits being transported within the payloads of alternate cells of a sequence of a predetermined number of cells.

Advantageously, the performance monitoring channel bits are transported within a CIS field of an AAL1-SAR-PDU (Adaptation Layer One segmentation and reassembly protocol data unit) header comprising the first octet of the cell payload.

Preferably the cell sequence comprises a sequence of eight cells and the performance monitoring channel is provided by four bits transported in respective alternate cells within that sequence.

The method introduces the capability for direct monitoring of data errors which affect users data, based on use of spare capacity within the existing cell structure to support a performance monitoring scheme operating across a block of cells, and hence user data. Thus, the method provides a mechanism for more-precisely estimating the key SLA measures identified for use with TDM circuit services, viz. BER, ES, SES and UA. This allows operators to evaluate more-precisely violations against the committed SLA guarantees.

According to another aspect of the invention there is provided a communications network arrangement in which time division multiplexed (TDM) traffic is transported in cells, each having a header and a payload, over an asynchronous (ATM) network, wherein a TDM performance monitoring channel is provided over the ATM network so as to provide performance data for the TDM traffic, said channel being embodied as a sequence of bits, said bits being transported singly within the payloads of alternate cells of a sequence of a predetermined number of cells.

According to a further aspect of the invention there is provided a method of transporting TDM (time division multiplexed) traffic together with a TDM performance monitoring channel over a ATM (asynchronous transfer mode) network, the method comprising: segmenting the TDM traffic at an ingress to the ATM network and packing the segmented traffic as payload data into ATM cells, providing each ATM cell payload with a segmentation and reassembly protocol data unit (SAR-PDU) containing a channel state information (CIS) field, a sequence number field, and a sequence number protection field, providing said performance monitoring channel by utilising spare bits in the CIS field in alternate cells, and determining from said sequence number protection and performance monitoring data at an egress of the TDM traffic from the ATM network a measure of the quality of transport of the TDM traffic over the ATM network.

According to another aspect of the invention there is provided an asynchronous transfer mode (ATM) cell stream comprising a sequence of cells transporting time division multiplexed (TDM) traffic, each cell having a header and a payload, wherein said cell stream incorporates a TDM performance monitoring channel embodied as a sequence of bits, said bits being transported within the payloads of alternate cells of a sequence of a predetermined number of cells.

In a preferred embodiment of the invention, TDM (time division multiplexed) traffic is transported together with a TDM performance monitoring channel over a ATM (asynchronous transfer mode) network. The TDM traffic is segmented at ingress to the ATM network and is packed as payload data into ATM cells. Each cell payload is provided with an AAL1 segmentation and reassembly protocol data unit (SAR-PDU) containing a channel state information (CIS) field, a sequence number field, and a sequence number protection field. A performance monitoring channel is provided by utilising spare bits in the CIS field in alternate cells. On egress from the ATM network, the sequence number protection and performance monitoring data provide a means of identifying both missing and corrupted cells so as to determine a measure of the quality of transport of the TDM traffic over the ATM network. The measured transmission quality may be compared with service levels defined in a service level agreement.

In a further embodiment of the invention, the performance monitoring channel may be multiplexed with the sequence number field.

Users of services such as private lines, which operators wish to carry within the network over CES connections, will continue to interwork directly with TDM circuits at the chosen data rate (e.g. TI/DS1). At the point in the network where CES is used, the data channel concerned is translated to packetised data which is then carried over the ATM network 11. This is done by means of CES Interworking Functions (IWFs) which ensure that TDM data received from a near-end user on a TDM “tail” is carried transparently through the ATM environment and is restored at the far-end onto the corresponding TDM “tail” to the far-end user. The intention is to provide a communications environment, which appears, as far as possible, equivalent to a conventional end-to-end TDM circuit between the users.

A set of service level agreement (SLA) measures will be used in the following description to identify the significant service impairments, which can arise. These SLA measures used for the typical TDM services carried by CES are defined as:

BER—Block, or Bit, Error Ratio: this measures the proportion of data blocks, or bits, which are errored compared with the total traffic, assessed over the SLA measurement period (typically, some weeks or months).

ES—Errored Seconds: this measures the number of seconds containing data errors, assessed over the SLA measurement period.

SES—Severely-Errored Seconds: this measures the number of seconds considered to contain a severe level of data errors, assessed over the SLA measurement period. Several ways of assessing a severe level of data errors are possible.

UA—Unavailable time: this measures the number of seconds where service is considered to be unavailable, assessed over the SLA measurement period. This measure is based on continuing periods of severely errored seconds (SES).

### BRIEF DESCRIPTION OF THE DRAWINGS

An embodiment of the invention and the best known method of putting the invention into practice will now be described with reference to the accompanying drawings in which:—

FIG. 1 is a general schematic view of a network arrangement in which an ATM network transports TDM traffic;

FIG. 2 shows the format of an ATM cell header employed in the network of FIG. 1;

FIG. 3 shows an error detection circuit employed in the network of FIG. 1;

FIG. 4 is a functional diagram of an errored second accumulation arrangement;

FIG. 5 is a functional diagram of a severely errored second counting arrangement;

FIG. 6a is a functional diagram of a background block error counting arrangement;

FIG. 6b is a timing diagram associated with the background block error counting arrangement of FIG. 6a; and

FIG. 7 is a functional diagram of an unavailable second counting arrangement.

### DESCRIPTION OF PREFERRED EMBODIMENT

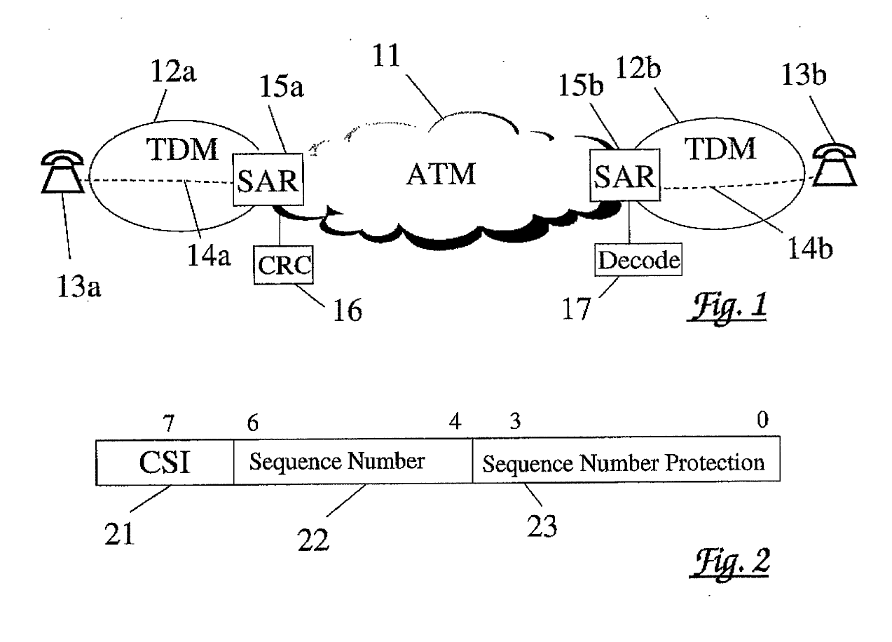

Referring first to FIG. 1, this shows a schematic form a telecommunications network arrangement in which an ATM network 11 transports TDM traffic from a first TDM network 12a to a second TDM network 12b. As shown in FIG. 1, the network arrangement provides a communications path via the ATM network 11 between first and second users 13a, 13b, each user being coupled to the ATM network via a respective TDM tail 14a, 14b. On ingress to the ATM network, the TDM traffic is segmented and packed as a payload into cells for transport over the ATM network. On egress from the ATM network, the cell payloads are reassembled into TDM frames. The processes of segmentation and reassembly will be familiar to those skilled in the art. Packaging of the TDM traffic into ATM cells and the recovery of the traffic from those cells is performed by segmentation and re-assembly (SAR) functions 15a, 15b.

In the network arrangement of FIG. 1, a TDM performance monitoring channel is provided over the ATM network, which channel is standards compliant, backward compatible, and requires minimal additional bandwidth. This performance monitoring channel is provided by CRC generator 16 and is carried over the ATM network with the TDM traffic as will be described below so as to provide the TDM network operator with end to end transparency. The TDM performance monitoring channel is supported within the ATM cell payload for transport across the ATM network. This overcomes the problem of lack of available user bits in the ATM cell header. In our arrangement and method, an “out of band” mechanism is incorporated in the AALI header comprising the first octet of the cell payload (AAL user information). On receipt of the ATM cells, the performance monitoring channel is recovered by decoder 17 and is utilised to provide measures of transmission errors.

The out of band scheme employed herein makes use of bandwidth available in the AAL1-SAR-PDU (Adaptation Layer One segmentation and re-assembly protocol data unit) header. The AAL1 header format shown in FIG. 2 constitutes the first eight bits (octet) of the cell payload and comprises a one bit (bit 7) CSI (channel state information) field 21, a three bit (bits 4 to 6) sequence number field 22, and a four bit (bits 0 to 3) sequence number protection field 23. The sequence number field thus counts cells in eight cell batches. It will of course be appreciate that a longer sequence field counting blocks of sixteen or more cells may be provided. The sequence number protection field typically contains a cyclic redundancy code (CRC).

In the AAL1-SAR-PDU format shown in FIG. 2, the CSI field 21 can have one of two purposes depending on whether the data transfer is structured or unstructured, For CES-SDT (circuit emulation service structured data transfer) the CSI field can identify the position of the structure pointer field, and for CES-UDT (unstructured data transfer) it can carry RTS (residual time stamp) values. In both cases, however, the CSI field 21 is occupied only in alternate cells. A structure pointer field occurs only in even numbered cells, as indicated by the parity of the content of the sequence number field 22, whilst RTS values are present only in odd numbered cells. This means that in both cases (structured or unstructured data transfer) capacity for a 4 bit channel is available in every sequence of 8 cells.

In our arrangement and method, the PM (performance monitoring) channel for CES-UDT is embodied as a bit in the (previously unused) CSI field in every even numbered cell. Similarly the PM channel for CES-SDT is embodied as a bit in the (previously unused) CSI field in every odd numbered cell. The PM channel thus comprises four bits in each block of eight cells.

Since the performance monitoring bit is covered by the sequence number protection mechanism, the payload check process itself is made more robust against random errors.

CRC Message Block at the Transmitter

A CRC (cyclic redundancy code) Message Block (CMB) comprises a set of bits which are grouped for the process of CRC calculations. As such, the CMB sets the granularity of the performance monitoring function

The AAL1 CMB (CRC message block) at the transmitter is defined as the payload (AAL user information) of 8 consecutive cells with sequence numbers 0 through to 7. This allows the sequence number field in the AAL1 header to act as a framing mechanism for the CMB. As described above, a sequence of eight cells provides, in our arrangement and method, capacity for four bits which are used for payload protection. A CRC-4, as used for E1, can detect all CRC error bursts of length four bits or less, and at least 87.5% of error bursts of greater than four bits in length.

The CMB for E1 is 2048 bits, as opposed to 3000 or 3008 bits for AAL1. The longer CMB does adversely affect error detection in that the larger granularity increases the likelihood of multiple errors within a CMB. Such errors only have an 87.5% probability of detection. The error rate, however, indicated by such a scenario is so high that the inaccuracy is insignificant. At such a rate cell loss will become the dominant factor in performance, and can be measured via the CES statistics.

Note that the CMB (CRC message block) does not include the AAL1 header (SAR-PDU header), which is protected independently by the SNP (sequence number protection) field 23, and the CES-SDT Pointer field, which is protected by a parity bit. This allows the CRC-4 to be generated below the SAR layer which is advantageous in implementations which do not have efficient CRC-4 logic available at the SAR layer, e.g. where the SAR layer is implemented using a processor.

The following table details our allocation of CRC bits within the CSI field over two consecutive batches of eight cells for both structured and unstructured data transfer.

TABLE

| CMB | AAL1 Sequence Number | Parity | CES-UDT CSI | CES-SDT CSI |
|---|---|---|---|---|
| N | 0 | Even | C₄ from CMB N-1 | Structure Painter indication |
| | 1 | Odd | RTS₄ | C₄ from CMB N-1 |
| | 2 | Even | C₃ from CMB N-1 | Structure pointer indication |
| | 3 | Odd | RTS₃ | C₃ from CMB N-1 |
| | 4 | Even | C₂ from CMB N-1 | Structure Pointer indication |
| | 5 | Odd | RTS₂ | C₂ from CMB N-1 |
| | 6 | Even | C_{1 from CMB N-1} | Structure Pointer indication |
| | 7 | Odd | RTS₁ | C₁ from CMB N-1 |
| N + 1 | 0 | Even | C₄ from CMB N | Structure Pointer indication |
| | 1 | Odd | RTS₄ | C₄ from CMD N |
| | 2 | Even | C₃ from CMB N | Structure Pointer indication |
| | 3 | Odd | RTS₃ | 3 from CMB N |
| | 4 | Even | C₂ from CMB N | tructure Pointer indication |
| | 5 | Odd | RTS₂ | C₂ from CMB N |
| | 6 | Even | C₁ from CMB N | Structure Pointer indication |
| | 7 | Odd | RTS₁ | C₁ from CMB N |

CRC Encoding Procedure

The CMB check bits C₁, C₂, C₃ and C₄ for CMB N+1 are calculated as the remainder after multiplication by x⁴ and then division (modulo 2) by the generator polynomial x⁴+x+1, of the polynomial representation of CMB N.

CRC Message Block at the Receiver

The CMB at the receiver is defined as the payload (AAL user information) carried by the shortest sequence of cells, starting with a cell with sequence number 0 and ending with a cell with sequence number 7. This definition implies that the sequence of cells forming the CMB may not be eight cells in length, which was the case at the transmitter. This may be the result of cell loss, CDV (cell delay variation) buffer overflow or underflow. Such errors are accounted by the CES statistics, and will likely translate to relatively large numbers of bit errors (on average 188 bit errors per cell lost). Thus, any inaccuracy in measuring payload errors over a variable length CMB is insignificant when combined with payload corruption at the cell level. The ‘Sequence Number’ of a dummy cell can be set to zero in order to prevent a CRC block error counter from accumulating multiple errors during periods of major disruption e.g. CDV buffer underflow. It may be the case, however, that block error counts are in fact discarded during such periods.

CRC Decoding Procedure

A CRC-4 is calculated on a received CMB as described above. The remainder resulting from this process is stored and subsequently compared on a bit by bit basis with the CRC bits received in the next CMB. If the remainder calculated at the decoder is identical to that received in the following CMB it is assumed that the CMB is error free. Any errors are used to increment a payload error counter. This counter can be polled in order to measure payload performance over a given period.

A preferred method for employing a user payload data CRC to determine SLA measures for CES connections will now be described

Bit Error Rate

The payload CRC provides a direct measure of block errors for a block spanning a contiguous group of 8 cells. Thus, BER can be measured simply by comparing a count of errored blocks with the overall blocks carried in the SLA measurement period.

Using the same notation as above, consider a CES connection at rate R bit/s. This will involve C cells/s carried, where:

C=R/376

The bit error rate BER is measured for the block errors B in a given period, as:

$$\begin{matrix}BER = B \text{/} ( C \text{/} 8 ) \\ = B * 8 \text{/} C \\ = B * 8 \text{/} ( R \text{/} 376 ) \\ = ( B * 3008 ) \text{/} R\end{matrix} \qquad ( 3 )$$

Note that, as defined in the relevant standards, the errored block count on which BER is based is not incremented during seconds assessed as UA or SES. As block errors are assessed directly for each block, it is straightforward to associate these errors with the second concerned, and to hold increments to the overall block error count until assessment of SES and/or UA has been established.

Errored Seconds

ES is assessed directly, based on the detection of any errored block within the second concerned or disruptions to cell traffic which result in data impairments visible to the user. Examples of such disruptions are individual cell discard e.g. due to detection of non-correctable errors in cell headers, buffer overflow where one or more cells are discarded because the capacity of internal buffers has been exceeded, and buffer under run where incoming network traffic has been disrupted so that internal buffers have been exhausted and no user data is available to transmit. All these cell-related problems can be interpreted as impacting one or more cells and lead to the second (or seconds) involved being assessed as ES.

Thus, ES is assessed for each second when either:

One or more blocks within that second are detected as errored

Or One or more cells within that second are discarded

Or an interruption to cell traffic (e.g. buffer overflow or underrun) indicates cell loss within that second

Note that, as defined in the relevant standards, the ES count is not incremented during seconds assessed as UA. As ES is assessed directly for each second, it is straightforward to hold increments to the overall ES count until assessment of UA has been established.

Severely Errored Seconds

For the CES environment, with block-oriented data transfer in cells, the following definition applies.

“A 1-second interval during which at least 30% of the blocks received are errored, or at least one severely disturbed period occurred; a severely disturbed period occurs when, over a period of time equivalent to four contiguous blocks or 1 ms, whichever is larger, all the contiguous blocks are experiencing BER at least 10-2”.

The data errors can be due to individual bit errors in the data stream, or disruptions to cell traffic which result in data impairments visible to the user as discussed for ES above.

The definition above indicates that each block within a period which may be “severely-disturbed” should be assessed separately, to establish that every block has BER of 1e-2 (10⁻²) or worse. This means monitoring for a bit error ratio of 1e-2 in N contiguous blocks, where N is a minimum of 4, and grows with bandwidth to equate to the number of blocks within 1 ms. SES is assessed when a BER of 1e-2 in each of the N contiguous blocks is assessed.

In practice, we achieve this by maintaining a count of “severely-disturbed” blocks, i.e. blocks with BER of 1e-2 or worse, within each second. This count is incremented by 1 for every severely-disturbed block, and zeroed when any block is not severely-disturbed (since we would then not have contiguous severely-disturbed blocks). SES is then assessed when this count reaches N (where N is a minimum of 4 and grows with bandwidth to equate to the number of blocks within 1 ms).

Any cell-related problem, i.e. cell discard, insertion of dummy cell information, or buffer overflow, introduces sufficient errors that 1e-2 is guaranteed. This can be seen since a block spans 8 cells, i.e. ˜3 kbits, and any cell loss or replacement by a dummy cell introduces, on average, 188 errored bits. This guarantees a bit error rate much greater than 1e-2 within the block, and so any cell-related problem guarantees a severely-disturbed block. As already noted, SES is then assessed for a contiguous string of N such severely-disturbed blocks.

Thus, SES is assessed for each second when:

30% of the blocks expected to be handled in that second are determined by the payload check to be errored, or are determined to be lost or replaced by dummy cell information due to an interruption to cell traffic (e.g. buffer overflow or under run)

And each of a contiguous group of blocks spanning 1 ms of transmission time (minimum of 4 blocks) is determined have been affected by cell-related problems (i.e. cell discard, insertion of dummy cell information, or buffer overflow)

Note that, as defined in the relevant standards, the SES count is not incremented during seconds assessed as UA (unavailable time). As SES is assessed directly for each second, increments to the overall SES count are held until assessment of UA has been established.

Unavailable Time

UA is assessed based on a sequence of seconds assessed as SES., BER update should not occur during a UA period or during any SES second (i.e. where SES is not within a UA period). ES and SES update should not occur during a UA period. The method for achieving this is described below.

For transitions from non-UA to UA, and from UA to non-UA, a transition count of SES status is maintained over a period of up to 10 seconds. While the connection is flagged as non-UA, this transition count is incremented for each SES second and zeroed by any non-SES second. If the transition count reaches 10, UA is flagged and the transition count zeroed. Until non-UA is determined, each second is then regarded as UA and the UA count incremented accordingly. While the connection is flagged as UA, the transition count is incremented for each non-SES second and zeroed by any SES second. If this transition count reaches 10, non-UA is flagged and the transition count zeroed, Special care must be taken during a transition between UA and non-UA, or between non-UA and UA, as this cannot be determined until the end of the transition period.

During a potential transition from non-UA to UA, i.e. when the connection is flagged as non-UA and SES is assessed, the BER, ES and SES counts are not incremented. However, the number of seconds for which ES or SES (separately) has occurred, and the number of errored blocks monitored, is recorded. If a non-SES second occurs, then the BER, ES and SES counts are incremented with the recorded data (since transition to UA has not occurred). If, on the other hand, UA is flagged (by the count of SES seconds reaching 10), the recorded BER, ES and SES data is discarded, and the main UA count is incremented (by 10) to reflect the requirement that the transition period is to be regarded as UA.

A similar scheme applies for potential transition from UA to non-UA, i.e. when the connection is flagged as UA and non-SES occurs. For this transition, the BER and ES counts are not incremented, and neither is the UA count itself. However, the number of seconds for which ES has occurred, and the number of errored blocks monitored, is recorded, as is the number of seconds for which transition is in progress, which equates to the number of seconds since commencement of non-SES. If an SES second occurs, then the recorded BER and ES data is discarded, since transition to non-UA has not occurred, and the UA count is incremented with the recorded data for the transition period, i.e. number of seconds of non-SES. If, on the other hand, non-UA is flagged, the BER and ES counts are incremented with the recorded data, but the UA count is not, since the transition period is not regarded as UA. Note that when incrementing the BER count because of transition to non-UA in this way, the count of seconds over which BER is assessed is incremented by 10 to allow for the transition period itself.

There now follows a description of a preferred method and apparatus in which the payload protection technique described above is used in order to support Service Level Agreements (SLAs) for TDM traffic transported over the ATM network.

Error Collection

As briefly discussed above, Service Level Agreements are defined in terms of the following standard parameters:

Background Block Error Ratio (BER)

The number or errored blocks divided by the total number of blocks, excluding periods which are Severely Errored or unavailable.

Errored Second (ES)

A one second interval with at least one bit error, excluding periods of unavailability.

Severely Errored Second (SES)

A one second interval having at least 30% of blocks received in error, or at least one severely disturbed period. A severely disturbed period occurs when over a period of time equivalent to four contiguous blocks or 1 ms, which ever is larger, all the contiguous blocks are affected by a high bit error density of at least 1e-2. The SES count is not updated during periods of unavailability.

Availability

A period of unavailable time begins at the onset of ten consecutive SES events. These ten seconds are considered to be part of unavailable time. A new period of available time begins at the onset of ten consecutive non-SES events. These ten seconds are considered to be part of available time. A count of the number of unavailable seconds is maintained. Availability is the ratio of available time to the measurement interval

In order to calculate these values accurately the following functions are performed:

Payload Check

The payload check mechanism is described above.

Dummy Data Insertion

Dummy data is inserted into the output data stream in response to lost cell events, or CDV buffer underflow. The amount of dummy data inserted is accumulated over an eight cell block period in order to determine whether that block is severely disturbed. Any dummy data, with the exception noted below, is used to indicate an errored block.

Dummy data may also be inserted in order to perform controlled frame slip for structured data transfer. This type of Dummy data is ignored as it is simply an effect of an anomaly which is accounted for elsewhere. A specific example of this is structure pointer reframe, which results from an anomaly in the PDH environment, but does not indicate errors in the operation of the CES/ATM environment, and so is not counted at all. The effect of CDV buffer overflow, however, is accounted for since it is a CES phenomenon. The quantification of the effect is not based on the amount of inserted dummy data.

CDV Buffer Overflow

The effect of CDV buffer overflow on the traffic stream is to discard CDV Buffer Size—CDVT data. This value is dependent on the settings for a particular connection. When a CDV buffer overflow is detected, the CDV buffer level check block indicates both severely disturbed block and errored block as appropriate for the size of disturbance created by the overflow, e.g. an overflow which resulted in the discard of 24 cells would result in either 3 or 4 severely disturbed block indications and dummy data indications, depending on the alignment of the overflow event with respect to the block boundary.

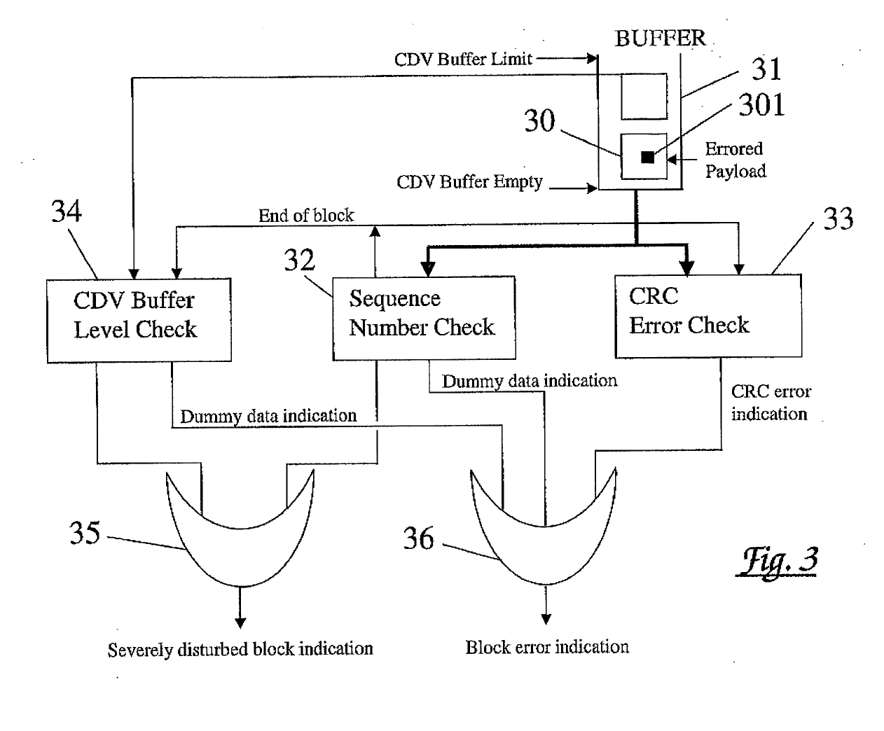

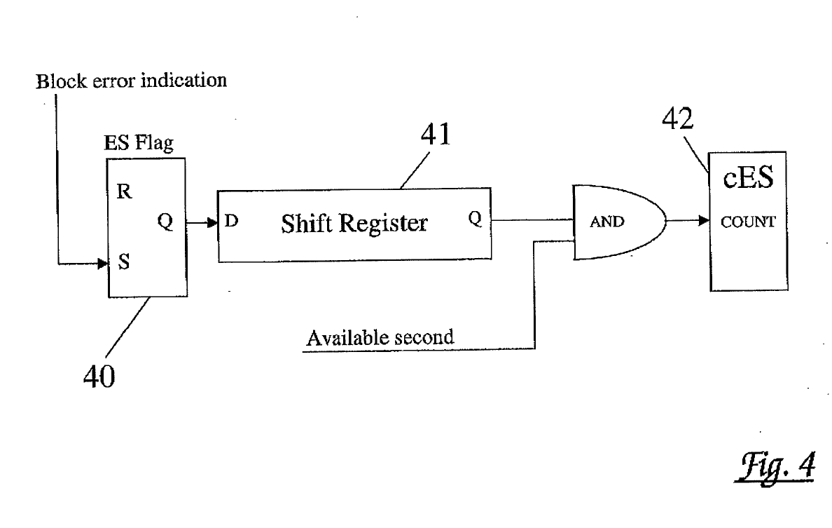

Referring now to FIG. 3, this shows a functional diagram for collecting or identifying errors of the types listed above. As can be seen from FIG. 3, the received payloads 30 are stored in a buffer 31 from which the individual payloads are processed in sequence. The first octet of each payload, i.e. the segmentation and re-assembly protocol data unit header, is decoded to check for missing cells via sequence number check circuit 32, and to detect transmission errors 301 via CRC error check circuit 33. A detected transmission error, i.e. a CRC error indication, is output as a block error indication from gate 36. When cells are found to be missing, a severely disturbed block indication is output from gate 35. The sequence number check circuit also provides an indication of the end of each successive eight cell block. Monitoring of the buffer fill level to detect buffer overfill or underfill is performed by level check circuit 34.

Note that the effect of a CDV Buffer overflow may overlap with subsequent error events. This is a consequence of quantifying the overflow event in terms of block errors over time, rather than a single discontinuity in the output traffic stream.

The parameters outlined above are combined in a synchronized manner in order to ensure that the calculations comply to the specifications above.

Errored Second Count

Referring now to FIG. 4, this is a functional diagram of an errored second accumulator. The accumulator receives as its input the block error indication from the error detection circuit of FIG. 3. There a three significant sources of bit errors: random payload errors, detected by the payload check, lost cells, detected by AAL1 sequence number processing, and timing mismatches, detected by monitoring the till level of the CDV buffer fill level. A errored second (ES) flag 40 is set when any of these events occurs. This flag is written into a ten stage shift register 41 at the end of each one second interval.

The one second interval is measured by means of a two second timer. The output of the timer indicates odd or even seconds, referred to subsequently as the phase of the timer. When a cell is processed on a particular connection, the timer phase is checked. If the phase of the timer is seen to be different from the phase when a cell was last processed on the same connection, then a transition into a different second period is deemed to have occurred. The ES Flag value is written into the ES Shift Register, and the ES flag is cleared. This occurs prior to the processing of the incoming cell.

The SES pattern over a 10 second interval is used to determine the availability state of the connection. If a stored ES Flag is subsequently adjudged to have fallen within an available second, then the Errored Second count 42 is incremented, otherwise the ES Flag is ignored.

The Errored Second count 42 is accumulated over a pre-set measurement interval. When the count is read, the value is then cleared for the start of the next measurement interval

Severely Errored Second Count

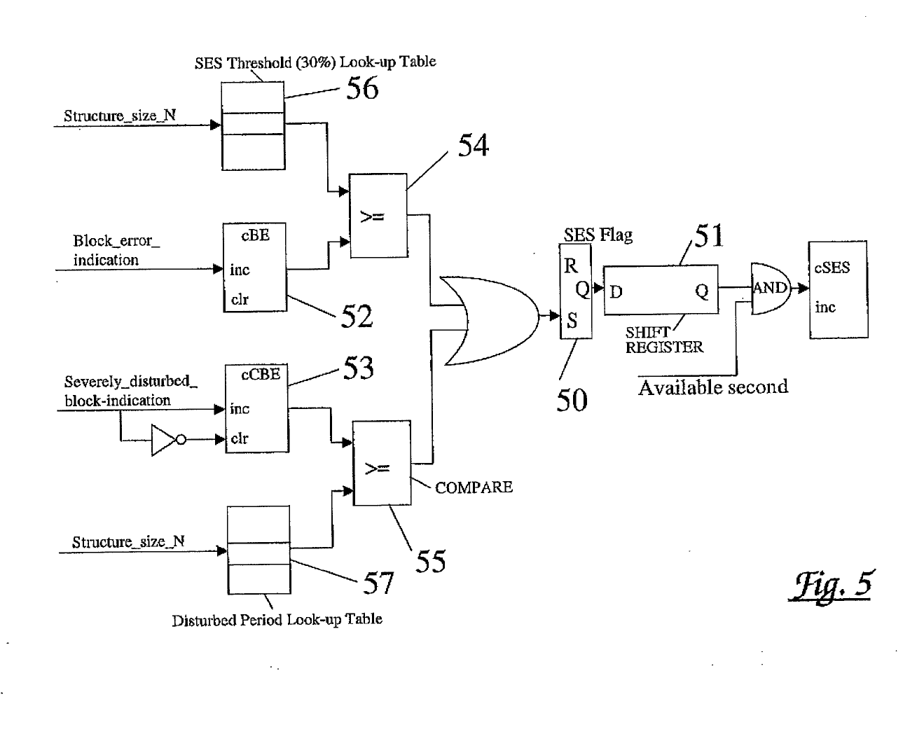

A functional diagram of a circuit for determining a severely errored second count is shown in FIG. 5. The circuit receives as its input both the block error indication and severely disturbed block indication outputs from the error detection circuit of FIG. 3. The number or count of errored blocks (cBE) 52 is accumulated over a one second interval. This cBE count 52 is continuously compared by comparator 54 against a 30% block threshold determined by means of a lookup table 56. When the block error count exceeds the threshold, a severely errored second flag (SES Flag) 50 is set. Similarly, the severely errored block indication count is compared by comparator 55 against a severely disturbed period threshold value determined by lookup table 57.

The severely disturbed period is determined by checking for a sequence of block errors. The length of the sequence is either four blocks, or the number of blocks occurring within a 1 ms period, whichever is the larger. The disturbance period, expressed as a number of blocks, is stored in the lookup table 57 which is addressed by the structure size. Unstructured links are assumed equivalent to N×64, where N is the total number of timeslots available. For E1 rate and below, the contiguous block error threshold is always four. The count of contiguous block errors (cCBE) 53 is incremented on when a severely disturbed block is detected, and cleared when a block is found not to be severely disturbed. When the contiguous block error threshold is exceeded the SES Flag 50 is set. This logic addresses the second clause of the SES definition.

At the end of the one second interval the SES flag 50 is shifted into a ten stage shift register 51, and all the cBE and cCBE counters, and SES flag, are cleared. The shift register 51 stores the SES value while the availability state is being determined. At the end of 10 seconds the SES count is incremented as determined by the SES Flag state read from the shift register and availability

The severely errored second count is accumulated over a predetermined measurement interval. When the count is read the value is cleared for the start of the next measurement interval.

Background Error Ratio

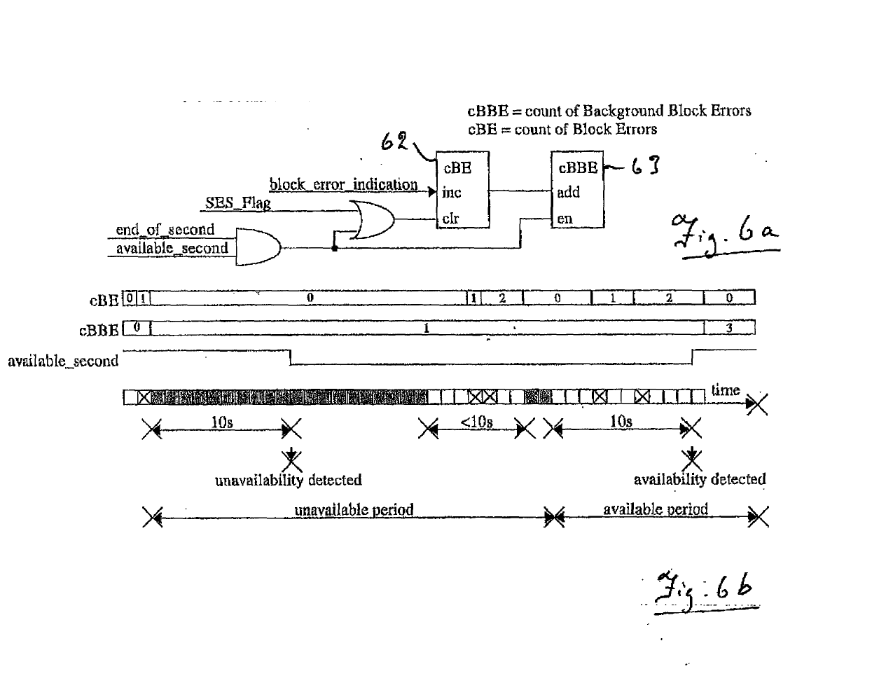

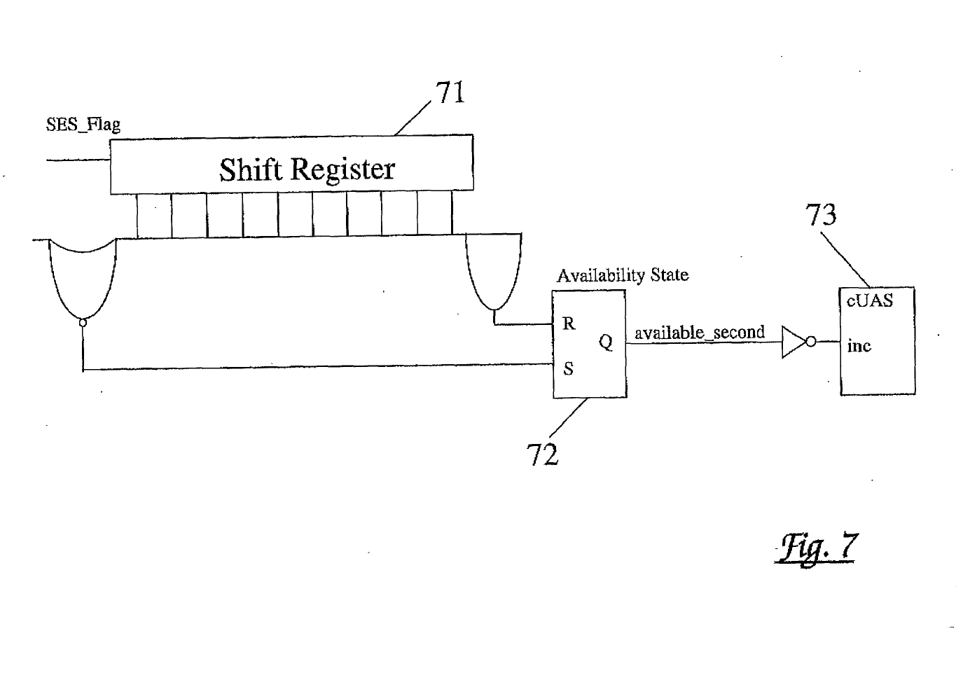

FIGS. 6a and 6b respectively show a background error counting circuit and its associated timing diagram. Errored blocks are blocks which fail the CRC check, and/or blocks which have dummy data inserted during the block. These events are ignored during SES (severely errored second) periods, which will include the ten seconds transition into the unavailable state. The events are accumulated in the count of block errors 62 during the transition from unavailable to available state, and are transferred into the count of background block errors 63 when a second is known to be an available second. This is shown in FIGS. 6a and 6b.

The counts are combined using the equation:

Block error ratio=cBBE/[(P−cUAS−cSES)*blocks per second

This gives the background block error ratio, where cBBE is the count of background block errors, P is the measurement interval, cUAS is the count of unavailable seconds and cSES is the count of severely errored seconds.

Unavailable Second Count

A functional diagram of a circuit for determining the unavailable second count is shown in FIG. 7. The count of unavailable seconds (cUAS) is determined by examining the recent history (e.g. ten seconds) of SES events. The history is stored in a shift register 71, and logic is used to decode the entry and exit conditions to the unavailable state. A single RS flip-flop 72 is used to store the state of the connection. The state is used to increment a counter 73 which then indicates the number of unavailable seconds (cUAS) during a measurement period. The count 73 is cleared when it is read at the end of the measurement interval.

Advantageously, the spare bits in the AAL1 cell structure that are used for performance monitoring as described above may be used to provide sequence numbering of cells so that extended periods of disrupted cell traffic can be correctly identified.

The above description of a payload check mechanism makes use of spare bits carried in a CIS field in the AAL1 Header. The performance monitoring (CRC) data carried in these bits becomes effectively redundant in an environment where there are no errors, or partially redundant in the presence of very low error rates. A sequence number, which effectively provides a continuity check on the information stream, has similar properties with respect to redundancy where no errors, or very few errors are experienced. The following describes a modification to the method described above in which these two information types are combined in order to reduce bandwidth requirement.

In this modified method, the transmitter XORs the transmit CRC with a transmit sequence number. This effectively multiplexes the performance monitoring and sequence number channels. The receiver at first assumes there are no errors in the system. A receive CRC is calculated and is assumed to be the same as the transmit CRC. The receiver recovers the transmit sequence number by XORing the receive CRC with the encoded CRC/transmit sequence number field. A state machine is used to synchronize a receive sequence number to the decoded transmit sequence number. Errors during the synchronization process would cause the state machine to delay synchronization. Once synchronization is declared by receiving a valid sequence of sequence numbers, the receiver now assumes that the data stream contains random errors. These random errors manifest themselves as CRC failures. The receiver increments the received sequence number for each received CRC field. The received sequence number is XORed with the received CRC/transmit sequence number field to reveal the transmit CRC. Any CRC errors are deemed to be due to random errors until such time as the synchronization state machine finds alternate synchronization. This would occur due to a loss of continuity in the received data stream. The size of this disruption is equivalent to the difference between the receive sequence numbers as the state machine transitions to an alternate synchronization, taking due account of data received during the resynchronization process.

The process of synchronization produces periods of uncertainty during which both transmitted fields are effectively unknown. However, since resynchronization only occurs during major disruptions, which are relatively infrequent, then the loss of the CRC check during such periods has been found to be acceptable. In fact CRC errors are generally ignored during periods of major disturbance.

It will be understood that the above description of a preferred embodiment is given by way of example only and that various modifications may be made by those skilled in the art without departing from the spirit and scope of the invention.

1. A method of providing performance monitoring data for time division multiplexed (TDM) traffic transported in cells, each having a header and a payload, over an asynchronous (ATM) network, the method comprising; providing a TDM performance monitoring channel embodied as a sequence of bits, said bits being transported within the payloads of alternate cells of a sequence of a predetermined number of cells.

2. A method as claimed in claim 1, wherein said cell sequence comprises a sequence of eight cells and the performance monitoring channel is provided by four bits within that sequence.

3. A method as claimed in claim 2, wherein transmission errors in received cells are identified as block error indications, and missing cells are identified as severely disturbed block indications.

4. A method as claimed in claim 3, wherein the four bits constituting the performance monitoring channel comprise a four bit cyclic redundancy code.

5. A method as claimed in claim 4, wherein said performance monitoring channel provides a measure of bit error ration, errored seconds, severely errored seconds and unavailable time.

6. A method as claimed in claim 1, wherein said performance monitoring channel is multiplexed with a sequence number channel.

7. A method as claimed in claim 6, wherein said sequence number channel enables synchronisation between a transmitter and a receiver.

8. Software in machine readable form on a storage medium and arranged to perform a method as claimed in claim 1.

9. A communications network arrangement in which time division multiplexed (TDM) traffic is transported in cells, each having a header and a payload, over an asynchronous (ATM) network, wherein a TDM performance monitoring channel is provided over the ATM network so as to provide performance data for the TDM traffic, said channel being embodied as a sequence of bits, said bits being transported singly within the payloads of alternate cells of a sequence of a predetermined number of cells.

10. A method of transporting TDM (time division multiplexed) traffic together with a TDM performance monitoring channel over a ATM (asynchronous transfer mode) network, the method comprising: segmenting the TDM traffic at an ingress to the ATM network and packing the segmented traffic as payload data into ATM cells, providing each ATM cell payload with a segmentation and reassembly protocol data unit (SAR-PDU) containing a channel state information (CIS) field, a sequence number field, and a sequence number protection field, providing said performance monitoring channel by utilising spare bits in the CIS field in alternate cells, and determining from said sequence number protection and performance monitoring data at an egress of the TDM traffic from the ATM network a measure of the quality of transport of the TDM traffic over the ATM network.

11. Apparatus for providing performance monitoring data for time division multiplexed (TDM) traffic transported in cells, each having a header and a payload, over an asynchronous (ATM) network, the apparatus comprising; means for the method comprising; providing a TDM performance monitoring channel embodied as a sequence of bits, said bits being transported within the payloads of alternate cells of a sequence of a predetermined number of cells, and means for determining from said sequence number protection and performance monitoring data at an egress of the TDM traffic from the ATM network a measure of the quality of transport of the TDM traffic over the ATM network.

12. Apparatus as claimed in claim 11, wherein said cell sequence comprises a sequence of eight cells and the performance monitoring channel is provided by four bits within that sequence.

13. Apparatus as claimed in claim 12, and incorporating means for identifying transmission errors in received as block error indications, and means for identifying missing cells as severely disturbed block indications.

14. Apparatus as claimed in claim 13, wherein the four bits constituting the performance monitoring channel comprise a four bit cyclic redundancy code.

15. Apparatus as claimed in claim 4, wherein said performance monitoring channel provides a measure of bit error ratio, errored seconds, severely errored seconds and unavailable time.

16. A method as claimed in claim 1, wherein said performance monitoring channel is multiplexed with a sequence number channel.

17. A communications network incorporating apparatus as claimed in claim 11.

18. An asynchronous transfer mode (ATM) cell stream comprising a sequence of cells transporting time division multiplexed (TDM) traffic, each cell having a header and a payload, wherein said cell stream incorporates a TDM performance monitoring channel embodied as a sequence of bits, said bits being transported within the payloads of alternate cells of a sequence of a predetermined number of cells.

19. An ATM cell stream as claimed in claim 18, wherein each said cell sequence comprises a sequence of eight cells and the performance monitoring channel is provided by four bits within that sequence.
